(19) United States
(12) Patent Application Publication
(10) Pub. No.: US 2010/0241655 A1
(43) Pub. Date: Sep. 23, 2010

(54) APPARATUS FOR AND METHOD OF TRANSMITTING SENSING DATA OF SENSOR NODE FOR PROACTIVE DATA FILTERING IN WIRELESS SENSOR NETWORK

(76) Inventors: In-Hwan Lee, Seoul (KR); Bong-Soo Kim, Daejeon-city (KR); Cheol-Sig Pyo, Daejeon-city (KR); Jong-Suk Chae, Daejeon-City (KR); Sung-Rae Cho, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 12/741,672

(22) PCT Filed: Aug. 12, 2008
(86) PCT No.: PCT/KR08/04677

§ 371 Date: May 6, 2010

(30) Foreign Application Priority Data
Nov. 13, 2007 (KR) 10-2007-0115521

(51) Int. Cl. G06F 17/30

(52) U.S. Cl. 707/769; 707/E17.014; 707/E17.012; 707/797

(57) ABSTRACT

An apparatus for and a method of transmitting sensing data of a sensor node for proactive data filtering in a wireless sensor network are provided. In the apparatus and method, a request query of sensing data and timer parameters are received, local sensing data sensed in the sensor node in response to the received request query are detected, a driving time of a timer applying the timer parameters based on the request query is set, and the local sensing data are transmitted when the local sensing data do not overlap sensing data of a neighboring sensor node within a wireless reception range of the sensor node by overhearing the sensing data of the neighboring sensor node during the set driving time of the timer. Thus, since a data transferring path is selected considering the remaining energy of the node, the energy exhaustion of the node is distributed, thereby improve the lifespan of the network.

### TECHNICAL FIELD

The present invention relates to an apparatus for and a method of transmitting sensing data of a sensor node for proactive data filtering in a wireless sensor network, and more particularly, to an apparatus for and a method of transmitting sensing data of a sensor node for proactive data filtering in a wireless sensor network, whereby, when each sensor node in a wireless sensor network transmits sensing data, redundant and unnecessary sensing data are proactively filtered and an off so as not to be transmitted, in order to prevent unnecessary power consumption when the sensing data are aggregated.

The present invention is derived from a research project supported by the Information Technology (IT) Research & Development (R&D) program of the Ministry of Information and Communication (MIC) and the Institute for Information Technology Advancement (ITTA) [2005-S-038-03, Development of UHF RF-ID and Ubiquitous Networking Technology].

### BACKGROUND ART

A sensor network is defined as a wireless network consisting of a sensor node, which is capable of sensing, processing, and performing wireless communication, and a sink node, which is also referred to as a gateway or a base station and functions as a data central center. Sensor networks are largely used in the industry and general application areas thereof are as follows.

First, sensor networks are used in military applications for performing unmanned reconnaissance, surveillance, and command transfer. Second, they are used in environment al applications for monitoring environmental pollution, fires, and floods, and for examining land and environment conditions related to farming in agricultural areas. Third, they are used in home applications in which intelligent sensors are mounted not only on household appliances but also on lighting devices and windows and are remotely controlled to provide diverse convenient functions such as crime prevention. Fourth, they are used in intelligent building applications for performing automation and control through building monitoring and improving the energy efficiency. Fifth, they are sued in medical applications for patient management, health care, medicine control, systems for the disabled, etc. finally, they are used in physical distribution management and telematics applications for managing the physical distribution and quality of products.

The aforementioned applications of sensor networks have a common operational characteristic in that data trust be transferred from a source node actually sensing and generating sensing data to a sink node collecting the sensing data. During this process, the sensor nodes form or networks by themselves, without using a pre-set network.

### DISCLOSURE OF INVENTION

### Technical Problem

In a wireless sensor network, each node cooperatively aggregates sensor information for a common task and transfers the information to a user. To this end, the nodes should be designed so that the power consumption thereof for transferring the sensing data is minimized due to limited power resources.

Korean Laid-Open Publication No. 2005-0092231 discloses an operating system and a method for a low-power sensor module in a sensor network, wherein a sensor node is controlled to operate with optimal power consumption by classifying all tasks performed in the operating system as periodic tasks and non-periodic tasks.

The operating system and method disclosed in the aforementioned document relate to link adaptation. Therefore, separate from these inventions, a wireless sensor network should be designed to minimize power consumption while aggregating data in the wireless sensor network.

### Technical Solution

The present invention provides an apparatus for and a method of transmitting sensing data of a sensor node for proactive data filtering in a wireless sensor network, wherein when each sensor node in the wireless sensor network transmits sensing data in response to a request of a sink node, redundant and unnecessary sensing data are proactively filtered and cut off so as not to be transmitted, whereby preventing unnecessary power consumption when the sensing data are aggregated.

### ADVANTAGEOUS EFFECTS

In accordance with the present invention, unnecessary power consumption is prevented by proactively filtering data upon data aggregation in a wireless sensor network, thereby realizing a network which is more energy efficient. Accordingly, the power consumption on the whole sensor network is reduced and thus, the life span of the network is extended.

### DESCRIPTION OF DRAWINGS

The above and other features and advantages of the present invention will become more apparent by describing in detail exemplary embodiments thereof with reference to the attached drawings in which:

FIG. 1A is a view illustrating an example of the stricture of a wireless sensor network;

FIG. 1B is a view illustrating a process of transferring sensing data, without data aggregation, in the wireless sensor network of FIG. 1;

FIG. 1C is a view illustrating a process of transferring sensing data, through data aggregation, in the wireless sensor network of FIG. 1;

FIG. 2 is a block diagram illustrating the stricture of an apparatus for transmitting sensing data of a sensor node for data aggregation in a wireless sensor network according to an embodiment of the present invention;

FIG. 3 is a flow chart illustrating a method of transmitting sensing data, performed by the apparatus of FIG. 2;

FIG. 4 is a flow chart illustrating a method of transmitting sensing data in a wireless sensor network according to another embodiment of the present invention;

FIG. 5 is a view illustrating the stricture of an intelligent decision circuit of the apparatus for transmitting sensing data of FIG. 2, according to an embodiment of the present invention; and

FIG. 6 is a view illustrating a process of transferring sensing data according to the intelligent decision circuit of FIG. 5 in the wireless sensor network of FIG. 1, according to the embodiment of the present invention.

### BEST MODE

According to an aspect of the present invention, there is provided an apparatus for transmitting sensing data of a sensor node for proactive data filtering in a wireless sensor network, comprising: a request query receiving unit for receiving a request query for sensing data and timer parameters; a local sensing data detecting unit for detecting local sensing data of a sensor node in response to the received request query; a timer setting unit for setting a driving time of a timer applying the timer parameters based on the request query; and a local sensing data transmitting unit for transmitting the local sensing data when the local sensing data do not overlap sensing data of a neighboring sensor node by overhearing the sensing data of the neighboring sensor node that is in a wireless reception range of the sensor node during the set driving time of the timer.

According to another aspect of the present invention, there is provided a method of transmitting sensing data of a sensor node for proactive data filtering in a wireless sensor network, comprising: receiving a request query of sensing data and timer parameters; detecting local sensing data of a sensor node in response to the received request query; setting a driving time of a timer applying the timer parameters based on the request query; and transmitting the local sensing data when the local sensing data do not overlap sensing data of a neighboring sensor node, by overhearing the sensing data of the neighboring sensor node that is in the range of wireless reception of the sensor node during the set driving time of the timer.

According to another aspect of the present invention, there is provide a computer readable recording media having recorded thereon a program for executing the method of transmitting sensing data of a sensor node in a wireless sensor network.

### MODE FOR INVENTION

The following disclosure illustrates only the principles of the present invention. Therefore, those skilled in the art may embody this invention in many alternate forms which are not clarified or illustrated herein but realize the principles of the invention and fall within the concept and scope of the invention. Further, it shall be understood that, in principle, all conditional terms and embodiments used herein are clearly for the purpose of describing the concept of the invention to be understood only and are not intended to be limiting of the particular embodiments and conditions of the invention set forth herein. It shall be further understood that all detailed description of not only the principles, viewpoints and embodiments of the invention but also the particular embodiments are intended to cover the structural and functional equivalents thereof. It shall be further understood that the equivalents include not only those being open at present but also those to be developed in the future, that is, all devices to be invented to perform the same functions as the present invention, irrelevant to the stricture of the invention.

Accordingly, the functions of various devices, which are illustrated in the accompanying drawings, including a processor or a functional block used in the concept being similar thereto, may be provided to be used for not only dedicated hardware but also hardware capable of running proper software. The functions provided by a processor may be provided by a single dedicated processor, a single shared processor, or a plurality of individual processors which may be partially shared. It shall be further understood that the terms used herein, such as ‘processor’, ‘control’ or the terms presented in the concept being similar thereto, should not be interpreted as excluding hardware which is capable of running software and will include, by implication, DSP (digital signal processor) hardware, ROM for storing software, RAM and nonvolatile memory. The terms may include any other well-known hardware.

The aforementioned objects, characteristics and advantages of the invention will be clearer in the detailed description with reference to the accompanying drawings. When the functions and constitution are well-known in the relevant arts, further discussion will not be presented in the detailed description of the invention in order not to unnecessarily make the gist of the present invention unclear. Preferred embodiments of the present invention will now be described more fully hereinafter with reference to the accompanying drawings.

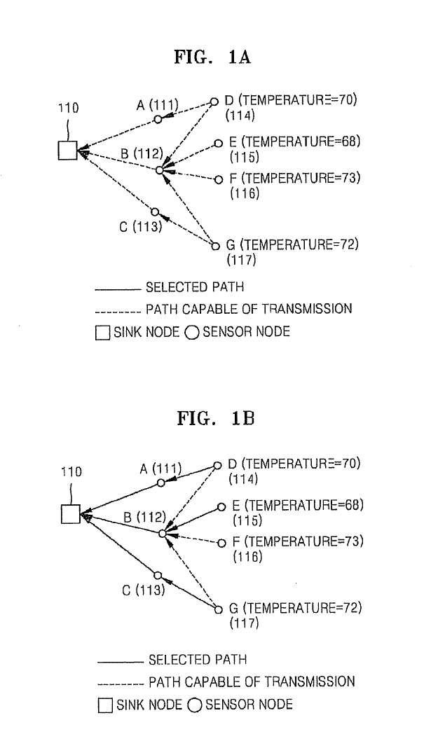

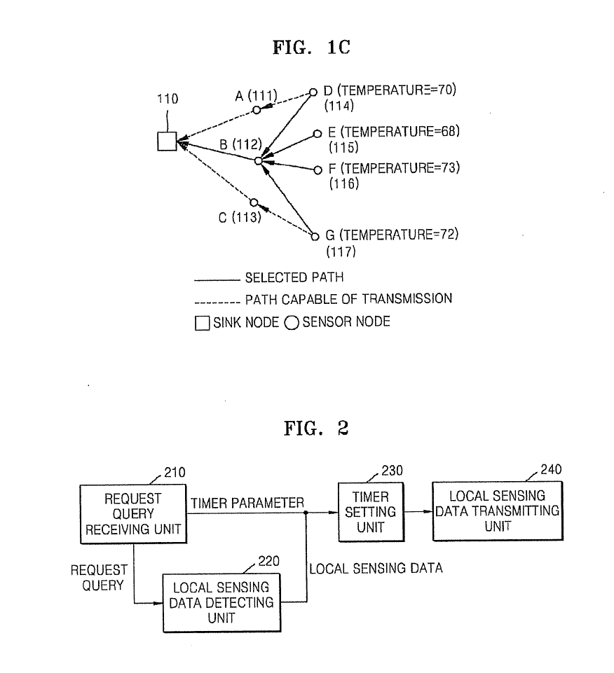

FIG. 1A is a view illustrating the general stricture of a wireless sensor network in a tree stricture.

Referring to FIG. 1A, the wireless sensor network consists of one sink node 110 and at least one or more sensor nodes 111, 112, 113, 114, 115, 116, and 117. The sensor nodes can be divided into source nodes D, E, F and G for measuring actual sensing data and respectively corresponding to reference numerals 114, 115, 116 and 117, and intermediate nodes A, B and C for relaying the sensing data to the sink node and respectively corresponding to reference numerals 111, 112 and 113. The sink node 110 transmits a query to obtain a minimum value of temperature data of the whole wireless sensor network. The nodes D, E, F and G measure actual temperature data at the query, select a node to relay the temperature data from among the nodes A, B and C and transmit the temperature data to the selected node. The nodes A, B and C receive the temperature data transferred from the nodes D, E, F and G and relay the temperature data to the sink node 110.

FIG. 1B is a view illustrating a process of transferring the sensing data, without data aggregation, in the wireless sensor network of FIG. 1A.

Referring to FIG. 1B, the node D transfers the temperature data to the sink node 110 through the node A. The nodes E and F each transfer the temperature data to the sink node 110 through the node B. The node G transfers the temperature data to the sink node 110 through the node C. In this case, the number of selected paths, that is, the total number of times of transmission of all the sensor nodes, is seven.

FIG. 1C is a view illustrating a process of transferring the sensing data, through data aggregation, in the wireless sensor network of FIG. 1A.

In FIG. 1C, the nodes D, E, F and G transfer the temperature data to the sink node 110 through the node B. Since the query transferred from the sink node 110 requests the minimum value of the temperature data, the node B transmits the value 68° C. as the minimum value of the temperature data when data are aggregated. In this case, the total number of times of transmission of all the sensor nodes is five.

As the above-described data aggregation process forms the reverse tree topology from the multiple source nodes to the sink node when the sensor data is transferred, each intermediate node aggregates data from children nodes and removes unnecessary information. This data aggregation process is performed in a spatial rendezvous point.

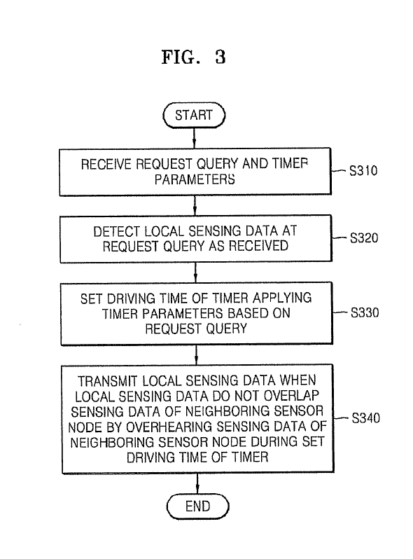

FIG. 2 is a block diagram illustrating the stricture of an apparatus for transmitting sensing data of a sensor node for data aggregation in a wireless sensor network according to an embodiment of the present invention, and FIG. 3 is a flow chart illustrating a method for transmitting sensing data, which is performed in the apparatus of FIG. 2.

Referring to FIG. 2, the apparatus comprises a request query receiving unit 210 receiving a request query for sensing data of a sensor node, a local sensing data detecting unit 220, a timer setting unit 230, and a local sensing data transmitting unit 240.

In operation S310, the request query receiving unit 210 receives the request query of the sensing data and timer parameters.

The request query of the sensing data is generated in a sink node of the wireless sensor network and is received by the sink node or other sensor nodes, i.e., parent nodes positioned at a high level in the tree topology having the sink node as a root. There are two types of queries, that is, one query to request a single sample and the other query to request a plurality of samples. Examples of the query to request a single sample include a request for a minimum value in order to request a single sample with a minimum value among the sensing data of each sensor node, a request for a maximum value in order to request a single sample with a maximum value among the sensing data of each sensor node, and a request to confirm if a single sample indicating whether a specific target to be sensed exists or not among the sensing data of each sensor node. With regard to the confirmation request, the specific target to be sensed may be, for example, an outside attack a fire occurrence, or the like within the sensing region of the sensor node.

The timer parameters include upper and lower limit values of the sensing data, a basic waiting time value, and other values sixth as the parameters used when the sensor nodes receive the query for driving their own timer.

In operation S320, the local sensing data detecting unit 220 detects local sensing data of the sensor node in response to the request query received in the request query receiving unit 210.

When the sensor node is an intermediate node of the tree stricture, the local sensing data detecting unit 220 includes a request query transmission unit (not shown) and a child node search unit (not shown).

The request query transmission unit (not shown) transmits the request query received in the request query receiving unit 210 to a child node at a low level with respect to the sensor node.

The child node search unit (not shown) receives the sensing data of the child node during a waiting time set according to the level of the sensor node and detects the sensing data as the local sensing data of the sensor node.

In operation S330, the timer setting unit 230 sets a driving time of a timer applying the timer parameters received in the request query receiving unit 210, based on the request query received in the request query receiving unit 210.

More specifically, when the request query received in the request query receiving unit 210 is a request for a minimum value, in order to increase the driving time of the timer in proportion to the size of the local sensing data, the timer setting unit 230 sets the driving time of the timer by applying a value which increases in proportion to the size of the local sensing data to the timer parameter.

When the request query received in the request query receiving unit 210 is a request for a maximum value, in order to decrease the driving time of the timer in proportion to the size of the local sensing data, the timer setting unit 230 sets the driving time of the timer by applying a value which decreases in proportion to the size of the local sensing data to the timer parameter.

When the request query received in the request query receiving unit 210 is a confirmation request, in order to set the driving time of the timer irrespectively of the size of the local sensing data, the timer setting unit 230 sets the driving time of the timer by applying a random value independent of the size of the local sensing data to the timer parameter.

When the request query received in the request query receiving unit 210 does not request a single sample, in order to set the driving time of the timer irrespectively of the size of the local sensing data, the driving time of the timer is set by applying a random value independent of the size of the local sensing data to the timer parameter.

The local sensing data transmitting unit 240 overhears the sensing data of a neighboring sensor node within a wireless reception range of the sensor node during the driving time of the timer set in the timer setting unit 230 and transmits the local sensing data when the local sensing data does not overlap the sensing data of the neighboring sensor node.

More specifically, the local sensing data transmitting unit 240 comprises a timer deactivation unit 241 and a transmission unit 242.

The timer deactivation unit 241 overhears the sensing data of a neighboring sensor node within the wireless reception range of the sensor node during the driving time of the timer set in the timer setting unit 230 and deactivates the timer when the local sensing data overlaps the sensing data of the neighboring sensor node.

For example, when the local sensing data overlaps the sensing data of the neighboring sensor node, and the request query is a request for a minimum value, the local sensing data is smaller than the sensing data of the neighboring sensor node, and when the request query is a request for a maximum value, the local sensing data is bigger than the sensing data of the neighboring sensor node. Further, when the request query is a confirmation request, the sensing data of a local sensor node is the same as the sensing data of the neighboring sensor node.

The transmission unit 242 transmits the local sensing data when the timer is not deactivated in the timer deactivation unit 241 and the driving time of the timer has elapsed. However, the transmission unit 242 does not transmit the local sensing data when the timer is deactivated.

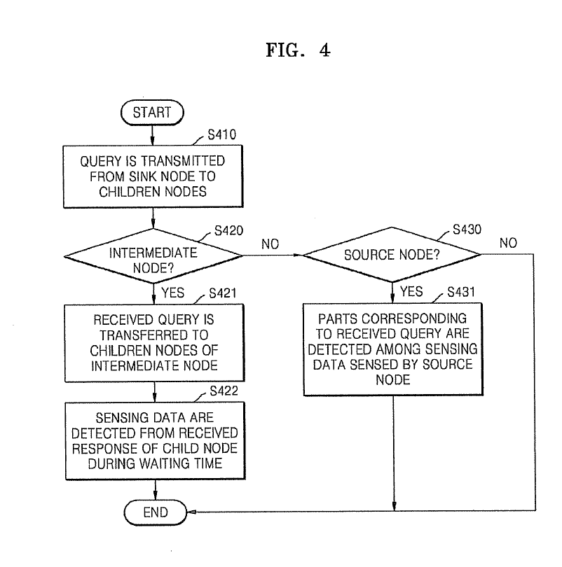

FIG. 4 is a flow chart illustrating a method of transmitting sensing data in a wireless sensor network according to another embodiment of the present invention.

Referring to FIG. 4, in operation 5410, a sink node of a wireless sensor network sets a query type, a depth of a tree and timer parameters in the query, and transmits the query to children nodes positioned at a low level in the tree topology having the sink node as a root.

The query type refers to whether the request query is a request for a minimum value, a request for a maximum value, a confirmation request, or a request for a plurality of samples. The depth of the tree means the number of maximum hops from the sink node to a terminal node positioned at the lowest level in the tree topology.

With regard to the parameters for the sensor nodes receiving the query to drive their own timer, the timer parameters include an upper limit value β and a lower limit value α of the sensing data, a basic waiting time value T, and other values.

When the request query is a request for a maximum value or a request for a minimum value from among the requests for a single sample, the sink node sets α, β and T and transmits them. Otherwise, the sink node sets μ and T and transmits them.

Each sensor node receives the query and detects the sensing data corresponding to the query.

More specifically, if in operation S420 the node receiving the query is an intermediate node, in operation S421 the node transfers the received query to its children nodes and waits as long as (D−d)T wherein d is the depth of a corresponding node. The waiting time allows the intermediate nodes to respectively receive all responses from their children nodes and the nodes having the same depth to be synchronized with one another.

In operation S422, the intermediate nodes detect the sensing data from the received responses of the children nodes during the waiting time of (D−d)T.

However, if in operation S430 the node receiving the query is the intermediate node, in operation 5431 the node detects a part corresponding to the received query from among the sensing data sensed by the node.

Subsequently, each sensor node sets the timer according to the query type and the timing parameters.

When the query type is a request for a minimum value, the driving time Bᵢ of the timer is expressed as

$$\begin{matrix}[ Equation 1 ] & \\ {B}_{i} = \frac{T ( χ - α )}{β - α} & [ Math . 1 ]\end{matrix}$$

where χ indicates the detected sensing data.

When the query type is a request for a maximum value, the driving time Bᵢ of the timer is expressed as

$$\begin{matrix}[ Equation 2 ] & \\ {B}_{i} = \frac{T ( β - χ )}{β - α} & [ Math . 2 ]\end{matrix}$$

When the query type is a confirmation request, the driving time Bᵢ of the timer is derived based on a probability density function as

$$\begin{matrix}[ Equation 3 ] & \\ {f}_{{B}_{i}} ( {b}_{i} ) = \{ \begin{matrix}\frac{μ {e}^{μ {b}_{i}}}{{e}^{μ T} - 1} , ( 0 \leq {b}_{i} \leq T ) \\ 0 , ( otherwise )\end{matrix} & [ Math . 3 ]\end{matrix}$$

When the timer stops operating, the sensor node transmits the sensing data. However, when the sensing data transmitted by other sibling nodes positioned within the wireless reception range of the sensor node are overheard before the timer stops operating, the sensor node compares its own sensing data with the overheard sensing data of the other nodes. When it is determined that the own sensing data are unnecessary because they overlap the overheard sensing data, the sensor node deactivates the timer.

When the query type is not a request of a single sample, the driving time Bᵢ of the timer is derived based on a probability density function as

$$\begin{matrix}[ Equation 4 ] & \\ {f}_{{B}_{i}} ( {b}_{i} ) = \{ \begin{matrix}\frac{μ {e}^{μ {b}_{i}}}{{e}^{μ T} - 1} , ( 0 \leq {b}_{i} \leq T ) \\ 0 , ( otherwise )\end{matrix} & [ Math . 4 ]\end{matrix}$$

When the timer stops operating, the sensor node transmits the detected sensing data, such as the request for a single sample. However, since there are no cases when the sensing data of the sensor node are determined as unnecessary due to the overlap, the timer is not deactivated, unlike in the case of the request for a single sample.

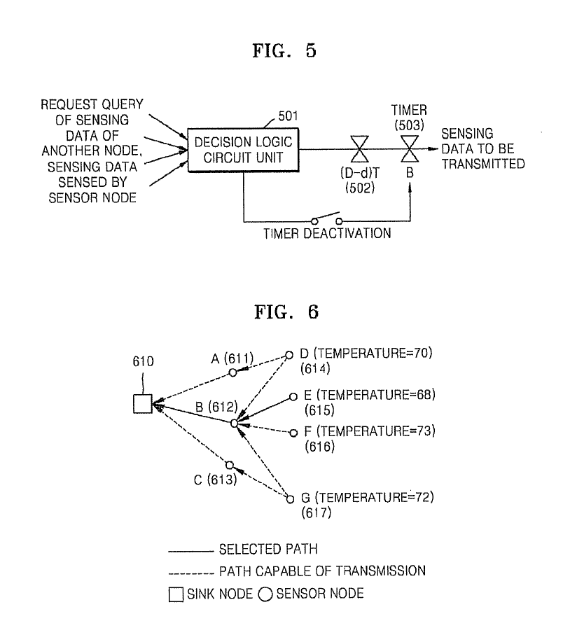

FIG. 5 is a view illustrating the stricture of an intelligent decision circuit of the apparatus for transmitting sensing data as illustrated in FIG. 2, and FIG. 6 is a view illustrating a process of transferring sensing data according to the intelligent decision circuit of FIG. 5 in the wireless sensor network of FIG. 1A.

Referring to FIGS. 5 and 6, in the intelligent decision circuit, a sensor node has the sensing data received from sensor nodes or generated in the sensor node and has a query received from a sink node. The sensor node having the sensing data and the query selects a node for routing the sensing data by a method of driving or deactivating a timer 503 through a decision logic circuit unit 501.

That is, nodes D 614, E 615, F 616 and G 617 drive the timer 503 as soon as they receive the query. Specifically, the timer 503 has a different driving time depending on the measured sensing data measured and the requested query. For example, when the query requests the temperature of a minimum value, the timer is driven for less time as the measured temperature data is smaller. In this case, the node E 615 drives the timer for the shortest time and the node F 616 drives the timer for the longest time. Therefore, the timer of the node 615 first stops operating and transfers its own temperature data to the node B 612. Then, the other sibling nodes D 614, F 616 and G 617 overhear the temperature data of the node E 615 and compare their own temperature data with the temperature data of the node E 615. As a result, since their own temperature data are unnecessary, the other sibling nodes D 614, F 616 and G 617 deactivate the timer 503 via the decision logic circuit unit 501, so that the transmission of their own temperature data is deactivated.

Consequently, when the query requests the temperature data of the minimum value, only the node E 615 measuring the temperature data of the minimum value responds to the query and transmits the measured temperature data. That is, the temperature data of the minimum value of the whole network is transmitted to the sink node by only a total of two times of transmission, thereby reducing the number of times of collision at the low level and preventing unnecessary power consumption.

The present invention can be realized as a computer readable code in a computer readable recording medium. The computer readable recording medium includes all kinds of recording devices which store data to be read by a computer system. Examples of the computer readable recording medium include ROM, RAM, CD-ROM, magnetic tapes, hard disks, floppy disks, flash memory, optical data storage devices and the like. Further, the computer readable recording medium includes, for example, what to be realized in the form of carrier waves (for example, transmission through internet). Further the computer readable recording medium can be distributed in a computer system connected by a computer communication net and it can be stored and run as a code to be read in a distributed manner. Further, a font ROM data stricture according to the present invention can be realized as a computer readable code in the recording media, such as computer readable ROM, RAM, CD-ROM, magnetic tapes, hard disks, floppy disks, flash memory, optical data storage devices and the like.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for transmitting sensing data of a sensor node in a wireless sensor network, comprising:
a request query receiving unit for receiving a request query of sensing data and timer parameters;
a local sensing data detecting unit for detecting local sensing data of the sensor node in response to the received request query;
a timer setting unit for setting a driving time of a timer applying the received timer parameters according to the request query; and
a local sensing data transmitting unit for overhearing sensing data of a neighboring sensor node within a wireless reception range of the sensor node during the set driving time of the timer, and transmitting the local sensing data when the local sensing data do not overlap the sensing data of the neighboring sensor node.

2. The apparatus of claim 1, wherein the wireless sensor network is formed in a tree structure and the local sensing data detecting unit comprises:
a request query transmission unit for transmitting the received request query to a child node of the sensor node; and
a child node search unit for receiving sensing data of the child node during a waiting time set depending on the level of the sensor node, and detecting the sensing data of the child node as the local sensing data of the sensor node.

3. The apparatus of claim 1, wherein the local sensing data transmitting unit comprises:
a timer deactivation unit for overhearing the sensing data of the neighboring sensor node during the set driving time of the timer and deactivating the timer when the local sensing data overlaps the sensing data of the neighboring sensor node; and
a transmission unit for transmitting the local sensing data when the timer is not deactivated and the driving time has elapsed.

4. (canceled)

5. The apparatus of claim 1, wherein, when the request query is a request for a minimum value to request a single sample having the minimum value from among the sensing data of at least one or more sensor nodes, the timer setting unit sets the driving time by applying a value increasing in proportion to the size of the local sensing data to the timer parameters.

6. The apparatus of claim 1, wherein, when the request query is a request for a maximum value to request a single sample having the maximum value from among the sensing data of at least one or more sensor nodes, the timer setting unit sets the driving time by applying a value decreasing in proportion to the size of the local sensing data to the timer parameters.

7. The apparatus of claim 1, wherein, when the request query is a confirmation request to request a single sample indicating whether a specific target to be sensed exists or not from among the sensing data of at least one or more sensor nodes, the timer setting unit sets the driving time by applying a random value irrespectively of the size of the local sensing data to the timer parameters.

8. The apparatus of claim 1, wherein, when the request query is a request for a minimum value to request a single sample having the minimum value from among the sensing data of at least one or more sensor nodes, the local sensing data transmitting unit transmits the local sensing data when the local sensing data is smaller than the sensing data of the neighboring sensor node.

9. The apparatus of claim 1, wherein, when the request query is a request for a maximum value to request a single sample having the maximum value from among the sensing data of at least one or more sensor nodes, the local sensing data transmitting unit transmits the local sensing data when the local sensing data is bigger than the sensing data of the neighboring sensor node.

10. The apparatus of claim 1, wherein, when the request query is a confirmation request to request a single sample indicating whether a specific target to be sensed exists or not from among the sensing data of at least one or more sensor nodes, the local sensing data transmitting unit transmits the local sensing data when the sensing data of the local sensor node indicate the existence of the specific target to be sensed.

11. The apparatus of claim 1, wherein, when the request query does not request a single sample, the timer setting unit sets the driving time by applying a random value irrespectively of the size of the local sensing data to the timer parameters.

12. (canceled)

13. A method of transmitting sensing data of a sensor node in a wireless sensor network, comprising:
receiving a request query of sensing data and timer parameters;
detecting local sensing data of the sensor node in response to the received request query;
setting a driving time of a timer based on the detected local sensing data and the received timer parameters; and
transmitting the local sensing data when the local sensing data do not overlap sensing data of a neighboring sensor node within a wireless reception range of the sensor node by overhearing the sensing data of the neighboring sensor node during the set driving time of the timer.

14. The method of claim 13, wherein the wireless sensor network is formed in a tree structure and the detecting of the local sensing data comprises:
transmitting the received request query to a child node of the sensor node; and
searching the child node by receiving sensing data of the child node during a waiting time set depending on the level of the sensor node and detecting the sensing data of the child node as the local sensing data of the sensor node.

15. The method of claim 13, wherein the transmitting of the local sensing data comprises:
deactivating the timer a timer when the local sensing data overlap the sensing data of the neighboring sensor node, by overhearing the sensing data of the neighboring sensor node during the set driving time of the timer; and
transmitting the local sensing data when the timer is not deactivated and the driving time has elapsed.

16. (canceled)

17. The method of claim 13, wherein, when the request query is a request for a minimum value to request a single sample having the minimum value from among the sensing data of at least one or more sensor nodes, the setting of the timer comprises: setting the driving time by applying a value increasing in proportion to the size of the local sensing data to the timer parameters.

18. The method of claim 13, wherein, when the request query is a request for a maximum value to request a single sample having the maximum value from among the sensing data of at least one or more sensor nodes, the setting of the timer comprises: setting the driving time by applying a value decreasing in proportion to the size of the local sensing data to the timer parameters.

19. The method of claim 13, wherein, when the request query is a confirmation request to request a single sample indicating whether a specific target to be sensed exists or not from among the sensing data of at least one or more sensor nodes, the setting of the timer comprises: setting the driving time by applying a random value being irrelevant to the size of the local sensing data to the timer parameters.

20. The method of claim 13, wherein, when the request query is a request for a minimum value to request a single sample having the minimum value from among the sensing data of at least one or more sensor nodes, the transmitting of the local sensing data comprises: transmitting the local sensing data when the local sensing data is smaller than the sensing data of the neighboring sensor node.

21. The method of claim 13, wherein, when the request query is a request for a maximum value to request a single sample having the maximum value from among the sensing data of at least one or more sensor nodes, the transmitting of the local sensing data comprises: transmitting the local sensing data when the local sensing data is bigger than the sensing data of the neighboring sensor node.

22. The method of claim 13, wherein, when the request query is a confirmation request to request a single sample indicating whether a specific target to be sensed exists or not from among the sensing data of at least one or more sensor nodes, the transmitting of the local sensing data comprises: transmitting the local sensing data when the sensing data of the local sensor node indicate the existence of the specific target to be sensed.

23. The method of claim 13, wherein, when the request query does not request a single sample, the setting of the timer comprises: setting the driving time by applying a random value irrespectively of the size of the local sensing data to the timer parameters.

24. (canceled)
